(19) United States
(12) Patent Application Publication
(10) Pub. No.: US 2024/0120477 A1
(43) Pub. Date: Apr. 11, 2024

(54) POSITIVE ELECTRODE MATERIAL FOR LITHIUM SECONDARY BATTERY AND METHOD OF MANUFACTURING SAME

(71) Applicants: HYUNDAI MOTOR COMPANY, Seoul (KR); KIA CORPORATION, Seoul (KR); INCHEON NATIONAL UNIVERSITY RESEARCH & BUSINESS FOUNDATION, Incheon (KR)

(72) Inventors: Seung Min Oh, Incheon (KR); Sung Ho Ban, Hwaseong-si (KR); Sang Hun Lee, Paju-si (KR); Chang Hoon Song, Seoul (KR); Yoon Sung Lee, Suwon-si (KR); Ko Eun Kim, Cheongju-si (KR); Van Chuong Ho, Incheon (KR); Jun Young Mun, Seoul (KR)

(21) Appl. No.: 18/219,370

(22) Filed: Jul. 7, 2023

(30) Foreign Application Priority Data
Oct. 6, 2022 (KR) 10-2022-0127897

(51) Int. Cl. H01M 4/525; H01M 4/04; H01M 4/485; H01M 4/505; H01M 4/62

(52) U.S. Cl. CPC H01M 4/525; H01M 4/0471; H01M 4/485; H01M 4/505; H01M 4/625; H01M 2004/028

(57) ABSTRACT

A positive electrode material for a lithium secondary battery has improved electron conductivity and surface stability because oxidation-treated carbon nanotubes are stably attached to the surface of an active material. According to one embodiment the positive electrode material includes a positive electrode active material core made of a Li—Ni—Co—Mn-M-O-based material (M=transition metal) and an oxidized carbon nanotube coating layer formed on the surface of the positive electrode active material core and including 1% to 3% by weight of oxidation-treated carbon nanotubes (OCNT) relative to 100% by weight of the positive electrode active material core.

### CROSS REFERENCE TO RELATED APPLICATIONS

The present application claims priority to Korean Patent Application No. 10-2022-0127897, filed Oct. 6, 2022, the entire contents of which is incorporated herein for all purposes by this reference.

### BACKGROUND

### 1. Field

The present disclosure relates to a positive electrode material for a lithium secondary battery and a method of manufacturing the same. More particularly, the present disclosure relates to a lithium secondary battery positive electrode material with improved electron conductivity and surface stability that are achieved by stably attaching oxidation-treated carbon nanotubes to the surface of a positive electrode active material, and to a method of manufacturing the same.

### 2. Description of the Related Art

Secondary batteries are used as large-capacity power storage batteries for electric vehicles and battery energy storage systems, and as small, high-performance energy sources for portable electronic devices such as mobile phones, camcorders, and laptop computers. With the aim of miniaturization and long-time continuous use of portable electronic devices, research is being conducted on weight reduction and low power consumption of secondary batteries, and there is the demand for compact high-capacity secondary batteries.

In particular, a lithium secondary battery, which is a typical secondary battery, has a higher energy density, a larger capacity per area, a lower self-discharge rate, and a longer life than a nickel manganese cell or a nickel cadmium cell. In addition, due to no memory effect, the lithium secondary battery has the advantages of convenient use and long service life.

A lithium secondary battery produces electric energy through oxidation and reduction reactions when lithium ions are intercalated/deintercalated in a state in which an electrolyte is disposed between a positive electrode and a negative electrode that are made of respective active materials enabling intercalation and deintercalation of lithium ions.

These lithium secondary batteries are mainly composed of a positive electrode material, an electrolyte, a separator, and a negative electrode material. For lithium secondary batteries having a long lifespan and reliably operating, an interfacial reaction between the components should be stable.

To improve the performance of a lithium secondary battery, research to improve a positive electrode material has been steadily conducted. In particular, a number of studies have been conducted to develop a high-performance, high-safety lithium secondary battery.

For example, Ni-rich positive electrode active materials are commercially available as a positive electrode material.

However, the Ni-rich positive electrode active materials are disadvantageous in that they have a lower electron conductivity and a lower ionic conductivity than other positive electrode active materials. For this reason, the Ni-rich positive electrode active materials are vulnerable to increased resistance and impose a limit on the fast charging and discharging performance of secondary batteries during the charging and discharging cycles.

In addition, the Ni-rich positive electrode active materials have limitations in terms of surface instability. Ni³⁺ state is a chemically unstable state in which upon exposure to an electrolyte, electrochemical side-reactions accelerate, resulting in increase in surface resistance. This may deteriorate the lifespan characteristics of secondary batteries or cause a cell-swelling phenomenon.

Therefore, various techniques for applying a carbon material on the surfaces of positive electrode active materials have been recently studied to improve surface stability and electron conductivity on the surfaces of positive electrode active materials that enable high energy capacity.

For example, a method of applying a carbon material on a surface of a positive electrode active material by using a carbon precursor and a method of depositing carbon on a surface of a positive electrode active material through sputtering are disclosed.

The carbon coating method using a carbon precursor includes a primary coating process of coating a surface of a positive electrode active material with carbon by applying a carbon-containing organic material (sucrose, glycol, etc.) on the surface and a post-heat carbonization process for carbonization to obtain a high conductivity. In this case, the higher the carbonization temperature, the higher crystalline carbon is obtained. This improves the electron conductivity. However, there is a problem that a carbon thermal reduction process in which CO₂ is produced by a chemical reaction of carbon and oxygen at temperatures above 400° C. is performed. Therefore, control of an inert gas atmosphere (for example, Ar atmosphere) is essential when a carbonization process is performed at temperatures above 400° C. However, oxide-based materials are susceptible to high-temperature Ar heat treatment. Therefore, oxide-based materials have limitations in terms that the high-temperature Ar carbonization process cannot be used.

Therefore, the carbon coating method using a carbon precursor is very limitedly applied to polyanion-based negative electrode materials with excellent crystallinity and stability, or to highly stable oxide materials such as Li₄Ti₅O₁₂, NaCrO₂, etc., and the method cannot be applied to Ni-rich materials that are unstable.

The carbon sputtering deposition on a surface of a positive electrode active material has an advantage of not requiring an oxide carbonization heat treatment process. However, since highly crystalline carbon cannot be deposited, the conductivity enhancement is limited. Moreover, mass production is constrained by carbon sputtering process facility.

On the other hand, a technique of simply mixing carbon nanotubes (CNTs) as a conductive material to introduce highly conductive carbon materials when forming electrodes has been proposed.

However, when a positive electrode active material and carbon nanotubes (CNTs) are simply mixed, it is difficult for the carbon nanotubes (CNTs) to be evenly dispersed on the surface of the positive electrode active material. In addition, there is a problem that the carbon nanotubes (CNTs) need to be used in a significantly large amount to achieve the desired conductivity.

The foregoing is intended merely to aid in the understanding of the background of the present disclosure, and is not intended to mean that the present disclosure falls within the purview of the related art that is already known to those skilled in the art.

### SUMMARY

The present disclosure provides a lithium secondary battery positive electrode material with high electron conductivity and surface stability and a method of manufacturing the same, the positive electrode material is obtained by stably attaching oxidation-treated carbon nanotubes to a surface of an Ni-rich positive electrode active material capable of enabling high energy capacity while maintaining a crystal structure of the Ni-rich positive electrode material.

The technical problems to be solved by the present disclosure are not limited to the ones mentioned above, and other technical problems which are not mentioned can be clearly understood by those skilled in the art from the following description.

According to one embodiment of the present disclosure, a positive electrode material for a lithium secondary battery includes a positive electrode active material core made of a Li—Ni—Co—Mn—M—O-based material (M=transition metal) and an oxidized carbon nanotube coating layer formed on a surface of the positive electrode active material core and including 1% to 3% by weight of oxidation-treated carbon nanotubes (OCNT) relative to 100% by weight of the positive electrode active material core.

The positive electrode active material core is represented by LiNiₓCo_{y}Mn_{z}M_{1-x-y-z}O₂ in which x, y, and z satisfies conditions of 0.3<x<1, 0<y<0.4, and 0<z<0.7, respectively.

The carbon nanotubes constituting the oxidized carbon nanotube coating layer has a length of 300 nm or more.

The carbon nanotubes constituting the oxidized carbon nanotube coating layer may have a carbon content of 97.5% to 98.5% and an oxygen content of 1.5% to 2.5% when analyzed by X-ray photoelectron spectroscopy (XPS).

According to one embodiment of the present disclosure, there is provided a method of manufacturing a positive electrode material for a lithium secondary battery, the method including: preparing a positive electrode active material core made of a Li—Ni—Co—Mn-M—O-based material (M=transition metal); heat treating carbon nanotubes (CNT) to oxidize the surfaces of the carbon nanotubes, thereby producing oxidation-treated carbon nanotubes (CNT); and coating the surface of the positive electrode active material core with the oxidation-treated carbon nanotubes (OCNT) to form a carbon nanotube coating layer on the surface of the positive electrode active material core.

In the preparing, the positive electrode active material core may be a material represented by LiNiₓCo_{y}Mn_{z}M_{1-x-y-z}O₂ in which x, y, and z satisfy the conditions of 0.3<x<1, 0 <y<0.4, and 0<z<0.7, respectively.

The heat treating may be performed in an air atmosphere in a temperature range of 200° C. to 500° C. for a duration of 1 to 5 hours.

The heat treating may be performed in a temperature range of 300° C. to 400° C.

In the coating, the oxidized carbon nanotube coating layer may be formed by attaching carbon nanotubes having an oxidation-treated surface to the surface of the positive electrode active material core through a physical coating method.

In the coating, the oxidation-treated carbon nanotubes are attached to the surface of the positive electrode active material core in a way that the positive electrode active material core and the oxidation-treated carbon nanotubes are introduced into a milling machine having a cylindrical rotor without blades rotated at the center thereof, and the rotor is rotated at a speed in a range of 2000 rpm to 4000 rpm for a duration of 10 minutes to 20 minutes.

In the coating, the amount of oxidation-treated carbon nanotubes attached to the surface of the positive electrode active material core is in a range of 1% to 3% by weight relative to 100% by weight of the positive electrode active material core.

In the coating, the oxidation-treated carbon nanotubes attached to the surface of the positive electrode active material core has a length of 300 nm or more.

The coating may be performed by a dry coating method.

On the other hand, a lithium secondary battery according to one embodiment of the present disclosure includes a positive electrode active material core made of a Li—Ni—Co—Mn—M—O-based material (M=transition metal), a positive electrode including a positive electrode material including an oxidized carbon nanotube coating layer formed on a surface of the positive electrode active material core and containing 1% to 3% by weight of carbon nanotubes having an oxidation-treated surface with respect to 100% by weight of the positive electrode active material, a negative electrode including a negative electrode active material, and an electrolyte.

In one embodiment of the present disclosure, oxidation-treated carbon nanotubes are stably attached to the surface of the positive electrode active material core while the crystal structure of the Ni-rich positive electrode active material core is maintained. Therefore, it is expected that high energy capacity is maintained, electron conductivity is increased, and surface stability is improved.

In particular, the stable attachment of the oxidation-treated carbon nanotubes to the surface of the positive electrode active material core through physical milling enables mass production of the positive electrode material without affecting the positive electrode active material core. That is, the positive electrode materials become available in mass production by using a coating method that does not affect the base materials thereof.

This enables a pure electric vehicle model to be built. Therefore, it is possible to reduce the manufacturing cost of a pure electric vehicle that is battery-driven compared to a hybrid or derivative electric vehicle in which a driving device is mounted on an existing vehicle structure.

### BRIEF DESCRIPTION OF THE FIGURES

FIG. 1 is a schematic view illustrating a positive electrode including a positive electrode material for a lithium secondary battery, according to one embodiment of the present disclosure,

FIG. 2 is a schematic view illustrating a process of coating a positive electrode active material core with carbon nanotubes when manufacturing a positive electrode material for a lithium secondary battery, according to one embodiment of the present disclosure;

FIGS. 3A and 3B are views illustrating respective proportions of C and O in each of a pure CNT and an oxidation-treated CNT, which are determined by X-ray photoelectron spectroscopy (XPS);

FIG. 4 is an SEM image showing a structure including a positive electrode active material core and pure carbon nanotubes (pure-CNTs) applied on the positive electrode active material core and a structure including a positive electrode active material core and oxidation-treated carbon nanotubes (OCNTs) applied on the positive electrode active material core;

FIG. 5 is a view illustrating XPS analysis results of a structure including a positive electrode active material core and pure-CNTs applied on the positive electrode active material core and a structure including a positive electrode active material core and OCNTs applied on the positive electrode active material core;

FIG. 6 is a view illustrating TGA analysis results according to heat treatment temperatures in an acid treatment step;

FIG. 7 is a view illustrating output characteristics of a secondary battery according to Control, Comparative Example, and Examples; and

FIG. 8 is a view illustrating initial efficiency performance of a secondary battery according to Control, Comparative Example, and Examples; and

FIG. 9 is a view illustrating the lifespan characteristics performance of a secondary battery for Control, Comparative Example, and Examples.

### DETAILED DESCRIPTION

Hereinafter, exemplary embodiments and examples of the present disclosure will be described in detail with reference to the accompanying drawings, in which like or similar components are designated by the same reference numerals, and redundant descriptions thereof will be omitted.

The terms “modules” and “units” used herein to represent constituent elements are named in consideration only the ease of description and are not intended to have distinct meanings or roles from each other by themselves.

In describing the embodiments and examples of the present disclosure, when a detailed description of an existing technology is determined to unnecessarily obscure the gist of the present disclosure, the detailed description may be omitted. It should also be understood that the accompanying drawings are intended to help an easy understanding of the embodiments disclosed herein, and that the technical idea disclosed herein is not limited by the accompanying drawings but covers all modifications, equivalents, and substitutions thereto.

Terms such as a first term and a second term may be used for explaining various constitutive elements, but the constitutive elements should not be limited to these terms. These terms are used only for the purpose of distinguishing a component from another component.

As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof.

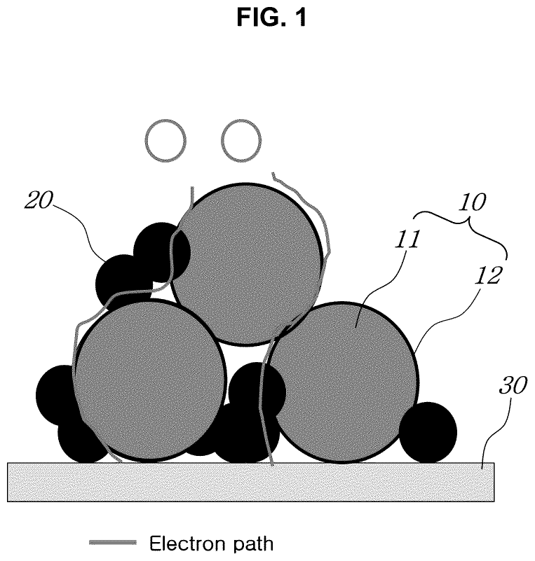

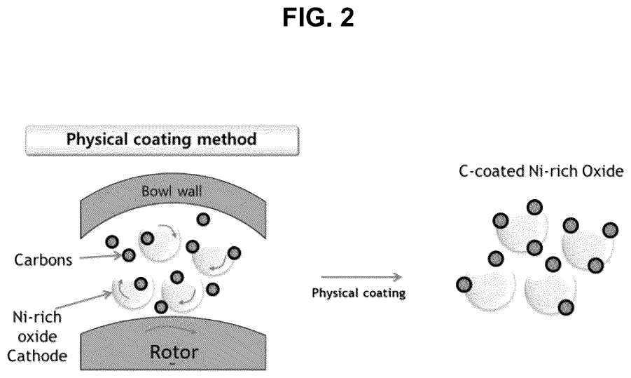

FIG. 1 is a schematic view illustrating a method of manufacturing a positive electrode material for a lithium secondary battery, according to one embodiment of the present disclosure, and FIG. 2 is a schematic view illustrating a method of coating a positive electrode active material core with carbon nanotubes.

Referring to FIG. 1, a positive electrode material 10 according to one embodiment of the present disclosure is a material constituting a positive electrode of a lithium secondary battery. The positive electrode material includes a positive electrode active material core 11 and an oxidized carbon nanotube coating layer 20 formed on a surface of the positive electrode active material core 11. The lithium secondary battery includes a positive electrode including the positive electrode material 10, a negative electrode including a negative electrode active material, and an electrolyte. In FIG. 1, reference numeral 20 represents a conductive material, and reference numeral 30 represents an electrode substrate 30 used to form a positive electrode.

The positive electrode active material core may be made of a Li—Ni—Co—Mn—M—O-based material that is rich in Ni and which enables reversible intercalation and deintercalation of lithium ions. Here, M represents a transition metal.

Preferably, the positive electrode active material core is represented by LiNiₓCo_{y}Mn_{z}M_{1-x-y-z}O₂ in which x, y, and z respectively satisfy the conditions of 0.3<x<1, 0<y<0.4, and 0<z<0.7.

The oxidized carbon nanotube coating layer is formed by physically attaching oxidation-treated carbon nanotubes (OCNTs) to the surface of the positive electrode active material core. The oxidation-treated carbon nanotubes constituting the oxidized carbon nanotube coating layer is a material that is physically attached to the surface of the positive electrode active material core to improve the electron conductivity of the positive electrode material.

It is preferable that the oxidation-treated carbon nanotubes attached to the surface of the positive electrode active material core have a length of 300 nm or more so that the oxidation-treated carbon nanotubes can be uniformly attached to the surface of the positive electrode active material core and thus the coating layer with a uniform thickness can be formed.

On the other hand, the proportion of oxygen (O) in the oxide-treated carbon nanotubes constituting the oxidized carbon nanotube coating layer is preferably four times higher than the proportion of oxygen in a pure carbon nanotube. For example, when the carbon nanotubes having an oxidation-treated surface, which constitute the oxidized carbon nanotube coating layer, undergoes X-ray photoelectron spectroscopy (XPS), the proportion of carbon (C) is preferably in a range of 97.5% to 98.5% and the proportion of oxygen (O) is preferably in a range of 1.5% to 2.5%.

Therefore, it is preferable that the amount of the oxidation-treated carbon nanotubes attached to the surface of the positive electrode active material core is in a range of 1% to 3% by weight relative to 100% by weight of the positive electrode active material core.

A method of manufacturing the positive electrode material will be described above.

According to one embodiment of the present disclosure, there is provided a method of manufacturing a positive electrode material for a lithium secondary battery, the method largely including: preparing a positive electrode active material core, heat treating carbon nanotubes (CNT) to oxidize the surfaces of the carbon nanotubes, thereby producing oxidation-treated carbon nanotubes (CNT), and coating the surface of the positive electrode active material core with the oxidation-treated carbon nanotubes (OCNT) to form an oxidized carbon nanotube coating layer on the surface of the positive electrode active material core.

The preparing is a process of preparing a positive electrode active material core.

In the process, an Ni-rich Li—Ni—Co—Mn—M—O-based material (M=transition metal) is prepared.

In addition, the positive electrode active material core is represented by LiNiₓCo_{y}Mn_{z}M_{1-x-y-z}O₂ in which x, y, and z respectively satisfy the conditions of 0.3<x<1, 0<y<0.4, and 0<z<0.7.

In the heat treating, pure carbon nanotubes (CNTs) are heat-treated in a high-temperature atmosphere so that the surfaces of the carbon nanotubes (CNTs) are oxidized.

Therefore, the carbon nanotubes having an oxidation-treated surface can inhibit side reactions occurring on the surface of the positive electrode material, thereby improving the initial efficiency and capacity of a secondary battery.

It is preferable that in the heat treating, the heat treatment is performed in an air atmosphere in a temperature range of 200° C. to 500° C. for a duration of 1 to 5 hours. More preferably, the heat treatment may be performed in a temperature range of 300° C. to 400° C.

When the heat treatment temperature is lower than the lower limit of the predetermined range, the surfaces of the carbon nanotubes are not sufficiently oxidized. When the heat treatment temperature is higher than the upper limit of the predetermined range, carbon defects may occur, resulting in reduction in electron conductivity that can be obtained by the carbon nanotubes.

Similarly, when the heat treatment time is shorter than the lower limit of the above-specified range, a problem that the surfaces of the carbon nanotubes are not sufficiently oxidized occurs. When the heat treatment time is longer than the upper limit of the above-specified range, there is a problem in that carbon defects occur and thus the electron conductivity that can be obtained by the carbon nanotubes.

In the coating, as illustrated in FIG. 2, an oxidized carbon nanotube coating layer is formed on the surface of the positive electrode active material core by attaching oxidation-treated carbon nanotubes to the surface of the positive electrode active material core through a physical coating method.

For example, a milling machine having a cylindrical rotor without blades rotated at the center is prepared. Then, a positive electrode active material core and oxidation-treated carbon nanotubes are introduced into the milling machine, and the rotor is rotated at a speed in a range of 2000 rpm to 4000 rpm for a duration of 10 minutes to 20 minutes. Thus, the oxidation-treated carbon nanotubes are attached to the surface of the positive electrode active material core.

When the rotational speed of the milling machine is lower than 2000 rpm, the oxidation-treated carbon nanotubes are not sufficiently attached to the surface of the positive electrode active material core. When the rotational speed of the milling machine is higher than 4000 rpm, the oxidation-treated carbon nanotubes are cut. Therefore, the oxidation-treated carbon nanotubes are not evenly attached to the surface of the positive electrode active material core. Therefore, the shortened oxidation-treated carbon nanotubes may cause a problem of deteriorating the electron conductivity of the positive electrode active material core.

In addition, when the coating time of the milling machine is shorter than 10 minutes, the oxidation-treated carbon nanotubes do not adhere sufficiently to the surface of the positive electrode active material core. When the coating time is longer than 20 minutes, the oxidation-treated carbon nanotubes are cut to be shorter.

Therefore, the length of the oxidation-treated carbon nanotubes after the completion of the coating by the milling machine is as short as 30% and 70% of the length of the oxidation-treated carbon nanotubes that are not yet introduced into the milling machine.

In the coating, the amount of oxidation-treated carbon nanotubes attached to the surface of the positive electrode active material core is preferably in a range of 1% to 3% by weight relative to 100% by weight of the positive electrode active material core.

In order for the oxidation-treated carbon nanotubes to be evenly attached to have a desired thickness on the positive electrode active material core, the positive electrode active material core that is used may have a particle size of 5 m or more, and the length of the oxidation-treated carbon nanotubes constituting the oxidized carbon nanotube coating layer on the surface of the positive electrode active material core is 300 nm or more at the point of time at which the coating by the milling machine is completed.

Next, the present disclosure will be described with reference to Control, Comparative Example, and Examples.

First, various examples, a comparative examples, and a control were prepared to determine the state and performance of a positive electrode material and a lithium secondary battery manufactured according to embodiments of the present disclosure.

### Example 1

LiNi_{0.89}Co_{0.04}Mn_{0.07}O₂ was prepared as a positive electrode active material core, and multi-walled carbon nanotubes (MWCNTs) were prepared as pure carbon nanotubes.

To oxidize the surfaces of the multi-walled carbon nanotubes, the prepared multi-walled carbon nanotubes (i.e., pure carbon nanotubes) (pure-CNTs) were placed in a furnace, air was introduced into the furnace at a flow rate of 200 cc/min, the temperature of the furnace was increased at a heating rate of 5° C./min, and heat treatment was performed for 2 hours at 300° C.

In addition, 2% by weight of the oxidation-treated carbon nanotubes (OCNTs) with respect to 100% by weight of the positive electrode active material core were added to a milling machine, and coating was performed at a rotation speed of 3000 rpm for 10 minutes.

The resulting positive electrode material, a conductive material, and a binder were mixed at a ratio of 95:2:3 in an NMP solvent to obtain a slurry. The slurry was applied on an aluminum substrate, dried, and rolled, and then dried in a vacuum oven to manufacture an R2032-type coin cell.

### Example 2

A coin cell was manufactured in the same manner as in Example 1, except that the heat treatment temperature of the pure carbon nanotubes during the heat treatment were 200° C.

### Example 3

A coin cell was manufactured in the same manner as in Example 1, except that the heat treatment temperature of the pure carbon nanotubes during the heat treatment was 400° C.

### Example 4

A coin cell was manufactured in the same manner as in Example 1, except that the heat treatment temperature of the pure carbon nanotubes during the heat treatment was 500° C.

### Comparative Example

A coin cell was manufactured in the same manner as in Example 1, except that a positive electrode active material core and untreated pure carbon nanotubes (pure-CNTs) were introduced into the milling machine.

Control: Bare

A slurry was prepared by mixing the same positive electrode active material core, the same conductive material, and the same binder as in Example 1 in an NMP solvent at a ratio of 95:2:3. The slurry was applied on an aluminum substrate, dried, and rolled, and then dried in a vacuum oven to manufacture an R2032-type coin cell.

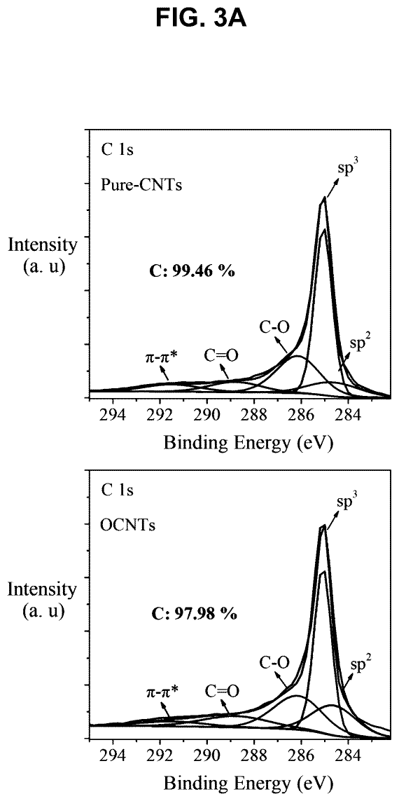

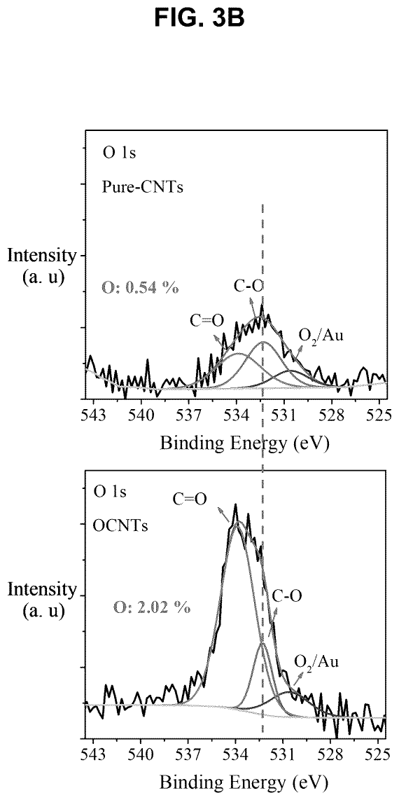

First, an XPS analysis was performed on the untreated pure carbon nanotubes (pure-CNTs) used in Example 1 and the oxidation-treated carbon nanotubes (OCNTs), and the resulting C and O proportions are shown FIGS. 3A and 3B.

FIG. 3A is a diagram illustrating a comparison in the proportion of C determined by the XPS analysis between the pure carbon nanotubes and the oxidation-treated carbon nanotubes, and FIG. 3B is a diagram illustrating a comparison in the proportion of O determined by the XPS analysis between the pure carbon nanotubes the oxidation-treated carbon nanotubes.

As illustrated in FIGS. 3A and 3B, the proportion of carbon (C) on the surface of the oxidation-treated carbon nanotubes (OCNTs) is reduced compared to that on the surface of the pure carbon nanotubes (Pure-CNTs), but the proportion of oxygen (O) is increased. In particular, it was found that although the proportion of oxygen was 0.054% in the pure carbon nanotubes, the proportion of oxygen increased by about four times to be 0.202% in the oxidized carbon nanotubes.

It is inferred that the heat treatment for oxidation of the surface of carbon nanotubes increases the oxidation functional groups on the surface of the carbon nanotubes.

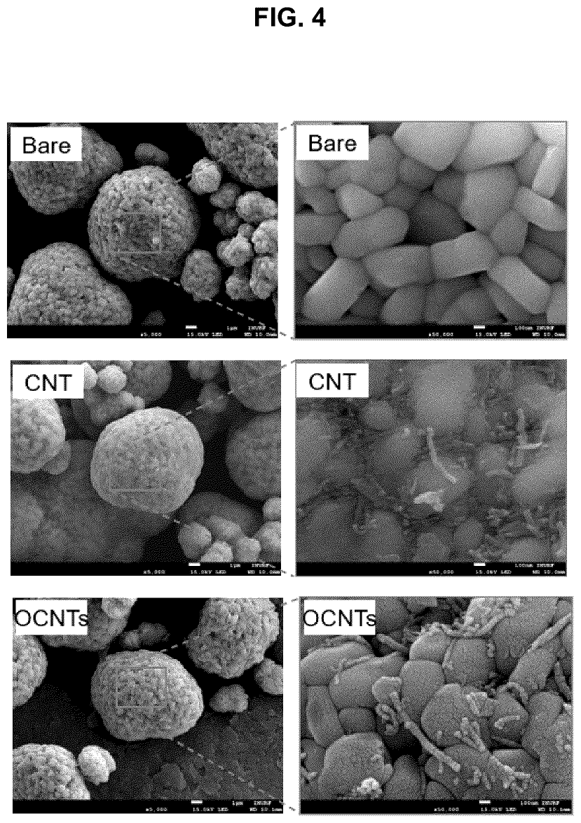

Next, SEM images of the positive electrode materials applied to Control, the Comparative Example, and Example 1 were taken, and the results are shown in FIG. 4.

Referring to FIG. 4, as in the comparative example, it was confirmed that in Example 1, the oxidation-treated carbon nanotubes (OCNTs) were uniformly attached to the surface of the positive electrode active material core.

Next, the surfaces of the positive electrode materials applied to the Control, Comparative Example, and Example 1 were analyzed by XPS, and the results are shown in Table 1.

TABLE 1

Classification

| | C | Li | Ni | Co | Mn | O |
|---|---|---|---|---|---|---|
| Control | 20.74 | 23.58 | 6.12 | 0.8 | 0 | 48.76 |
| Comparative | 60.32 | 8.6 | 4.62 | 0.56 | 0 | 25.91 |
| Example | | | | | | |
| Example 1 | 62.61 | 5.84 | 3.33 | 0.6 | 0 | 27.62 |

Referring to Table 1, in both Comparative Example and Example 1, the^{PGP}-2¹,T2 proportion of carbon (C) increased compared to Control. In particular, in Example 1, the proportion of carbon (C) increased compared to Comparative Example. Therefore, when the positive electrode material according to Example 1 is applied to a secondary battery, it is possible to improve the electron conductivity.

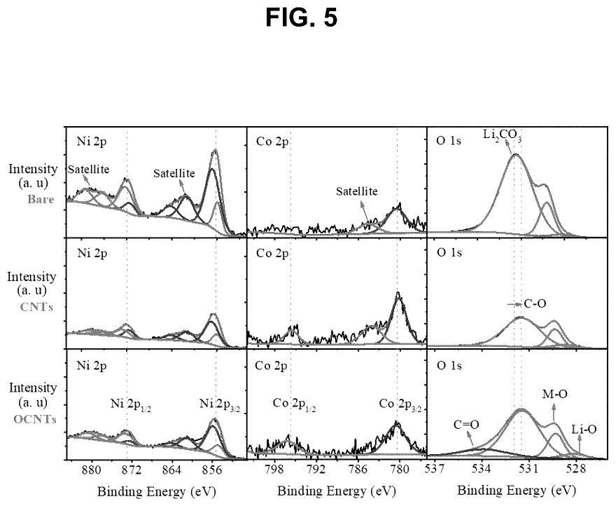

Next, the surfaces of the positive electrode materials applied to Control, Comparative Example, and Example 1 were analyzed by XPS, and the results are shown in FIG. 5.

Referring to FIG. 5, it was confirmed in Example 1, the spectrum of Ni generated in Ni-rich positive electrode active material core according to Control decreased.

It was confirmed that in Comparative Example and Example 1, pure-CNTs and OCNTs were uniformly applied on the surface of the positive electrode active material core.

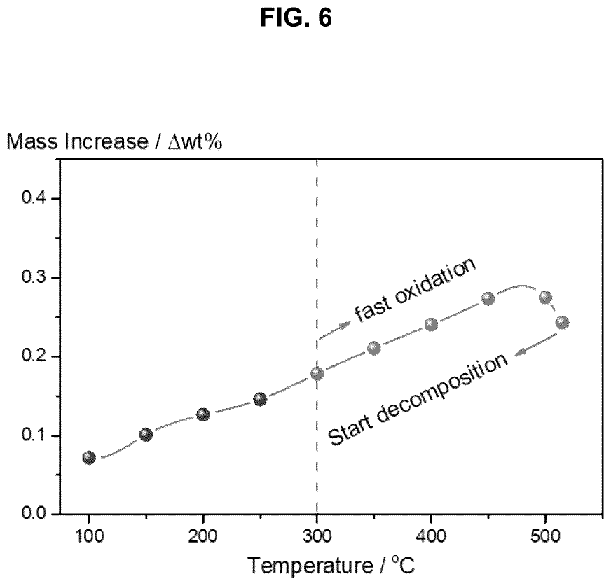

Next, to investigate the effect on the oxidation treatment of carbon nanotubes according to change in heat treatment temperature in the heat treatment, the surfaces of the carbon nanotubes were oxidized while changing the heat treatment temperature. The results are shown in FIG. 6.

Referring to FIG. 6, as the heat treatment temperature increases, the degree of oxidation on the surfaces of the carbon nanotubes increases.

However, it was confirmed that the carbon nanotubes decomposed when the heat treatment temperature exceeded 500° C., and more precisely 515° C.

In addition, it was confirmed that the degree of oxidation on the surfaces of the carbon nanotubes is excessively low when the heat treatment temperature is lower than 200° C.

Therefore, it was confirmed that the heat treatment for oxidation treatment was preferably performed in a temperature range of 200° C. to 500° C.

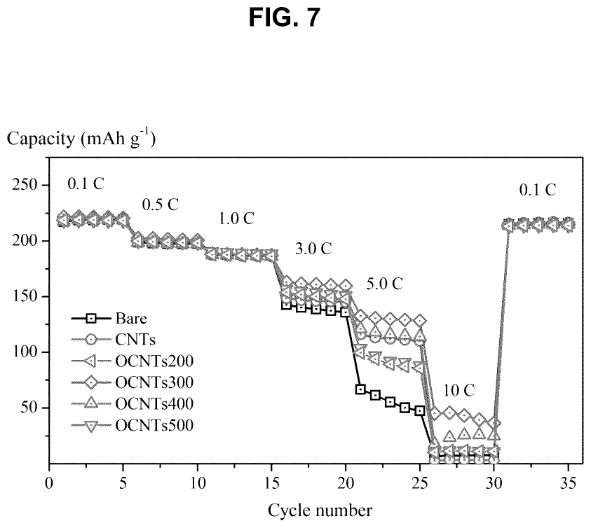

Next, the output characteristics of secondary batteries prepared according to Control, Comparative Example, and Examples were measured, and the results are shown in Table 2 and FIG. 7.

TABLE 2

| | 1^{st}/each condition | | | | | |
|---|---|---|---|---|---|---|
| | 0.1 C | 0.5 C | 1 C | 3 C | 5 C | 10 C |
| Control | 217.5 | 198.9 | 188.4 | 142.7 | 66.72 | 7 |
| Comparative | 218.5 | 200.4 | 187.5 | 148.5 | 115.8 | 2.8 |
| Example | | | | | | |
| Example 2 (200° C.) | 218.5 | 199.9 | 187.9 | 153.8 | 99.5 | 10.2 |
| Example 1 (300° C.) | 221.7 | 202.7 | 188.8 | 163.1 | 132.8 | 45.2 |
| Example 3 (400° C.) | 217.8 | 198.7 | 187.7 | 154.2 | 120.8 | 17.7 |
| Example 4 (500° C.) | 218.2 | 199.9 | 190.6 | 156.8 | 103.7 | 10.5 |

Referring to Table 2 and FIG. 7, it was confirmed that in Examples 1 to 4, the output characteristics at various current densities were generally improved compared to Control and Comparative Example.

In particular, it was confirmed that in Examples 1 and 3, the output characteristics at all current densities were improved compared to Control and Comparative Example.

Therefore, it was confirmed that the heat treatment for oxidation treatment was preferably performed in a temperature range of 200° C. to 500° C.

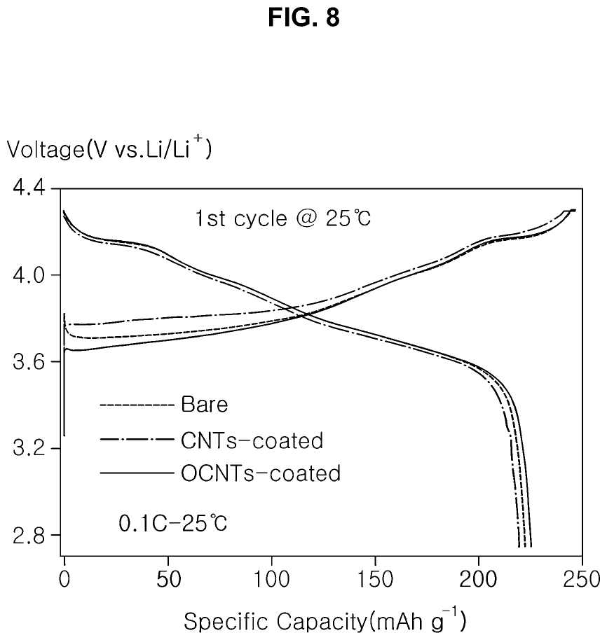

Next, the initial efficiency performance of each of the secondary batteries manufactured according to Control, Comparative Example, and Example 1 was measured, and the results are shown in FIG. 8.

FIG. 8 illustrates the results of initial efficiency measurement in an environment of 25° C.

Referring to FIG. 8, it was confirmed that in Example 1, the initial efficiency performance was improved compared to Control and Comparative Example.

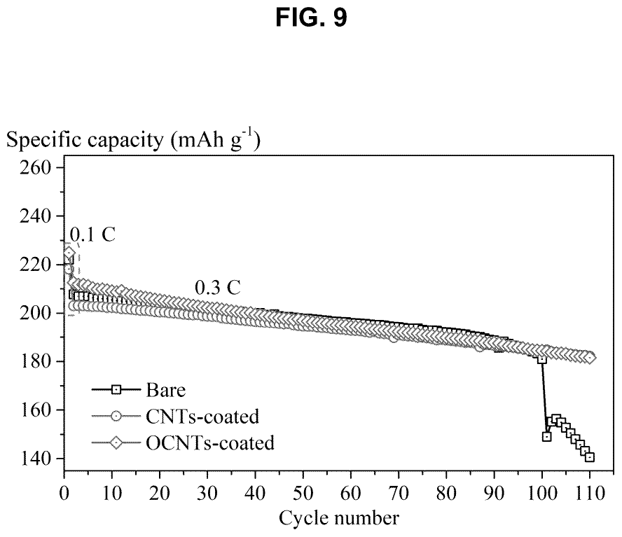

Next, the lifespan characteristic performance of each of the secondary batteries manufactured according to Control, Comparative Example, and Example 1 was measured, and the results are shown in FIG. 9.

Referring to FIG. 9, it was confirmed that in Example 1, the lifespan characteristic performance was significantly improved compared to Control.

In addition, it was confirmed that in Example 1, the lifespan characteristic performance was similar or improved compared to Comparative Example.

Although the present disclosure has been described with reference to the accompanying drawings and the preferred embodiments described above, the present disclosure is not limited thereto and is defined by the appended claims. Thus, those skilled in the art can diversely modify and change the present disclosure without departing from the technical spirit of the appended claims.

1. A positive electrode material for a lithium secondary battery, the positive electrode material comprising:
a positive electrode active material core made of a Li—Ni—Co—Mn—M—O-based material (M =transition metal); and
an oxidized carbon nanotube coating layer formed on a surface of the positive electrode active material core and comprising 1% to 3% by weight of carbon nanotubes (CNTs) having an oxidation-treated surface relative to 100% by weight of the positive electrode active material core.

2. The positive electrode material of claim 1, wherein the positive electrode active material core is represented by LiNiₓCo_{y}Mn_{z}M_{1-x-y-z}O₂, and satisfies 0.3<x<1, 0<y<0.4, 0<z<0.7.

3. The positive electrode material of claim 1, wherein the carbon nanotubes constituting the oxidized carbon nanotube coating layer has a length of 300 nm or more.

4. The positive electrode material of claim 1, wherein the carbon nanotubes constituting the oxidized carbon nanotube coating layer have a carbon content in a range of 97.5% to 98.5% and an oxygen content in a range of 1.5% to 2.5% when analyzed by X-ray photoelectron spectroscopy (XPS).

5. A method of manufacturing a positive electrode material for a lithium secondary battery, the method comprising:
preparing a positive electrode active material core made of a Li—Ni—Co—Mn—M—O-based material (M=transition metal);
heat treating carbon nanotubes (CNTs) to oxidize a surface of each of the CNTs to obtain oxidation-treated carbon nanotubes; and
coating a surface of the positive electrode active material core with the oxidation-treated carbon nanotubes to form an oxidized carbon nanotube coating layer.

6. The method of claim 5, wherein the positive electrode active material core is represented by LiNiₓCo_{y}Mn_{z}M_{1-x-y-z}O₂, and satisfies 0.3<x<1, 0<y<0.4, 0<z<0.7.

7. The method of claim 5, wherein the heat treating in the heat treating is performed in an air atmosphere in a temperature range of 200° C. to 500° C. for a duration of 1 hour to 5 hours.

8. The method of claim 7, wherein the heat treatment in the heat treating is performed in a temperature range of 300° C. to 400° C.

9. The method of claim 5, wherein in the coating, the oxidized carbon nanotube coating layer is formed by attaching the oxidation-treated carbon nanotubes to the surface of the positive electrode active material core through a physical coating method.

10. The method of claim 9, wherein in the coating, the oxidation-treated carbon nanotubes are attached to the surface of the positive electrode active material core in a way that the positive electrode active material core and the oxidation-treated carbon nanotubes are introduced into a milling machine having a cylindrical rotor without blades rotated at the center, and the cylindrical rotor is rotated at a speed in a range of 2000 rpm to 4000 rpm for a duration of 10 minutes to 20 minutes.

11. The method of claim 10, wherein in the coating, the amount of the oxidation-treated carbon nanotubes attached to the surface of the positive electrode active material core is in a range of 1% to 3% by weight relative to 100% by weight of the positive electrode active material core.

12. The method of claim 10, wherein in the coating, the oxidation-treated carbon nanotubes attached to the surface of the positive electrode active material core has a length of 300 nm or more.

13. The method of claim 5, wherein the coating is performed by a dry coating method.

14. A secondary battery comprising:
a positive electrode comprising the positive electrode material according to claim 1;
a negative electrode comprising a negative electrode active material; and
an electrolyte.
